(19) United States
(12) Patent Application Publication
(10) Pub. No.: US 2002/0150711 A1
(43) Pub. Date: Oct. 17, 2002

(54) Multilayered flexible line

(76) Inventors: Volker Schulz, Waechtersbach (DE); Tevfik Severengiz, Gelnhausen (DE); Wilfried Zuelch, Gelnhausen (DE)

Correspondence Address: Robert S. Swecker, BURNS, DOANE, SWECKER & MATHIS, L.L.P., P.O. Box 1404, Alexandria, VA, 22313-1404, US

(21) Appl. No.: 10/117,221

(22) Filed: Apr. 8, 2002

(30) Foreign Application Priority Data
Apr. 9, 2001 (DE) 101 17 753.4

(51) Int. Cl. B32B 1/08

(52) U.S. Cl. 428/36.91; 428/36.9

(57) ABSTRACT

The present invention relates to a multilayered line comprising at least one support layer and at least one electrically conductive section which is at least indirectly connected to the support layer. According to the invention, to give such a multilayered line a longer service life while ensuring an adequate electrical conductivity at the same time, the conductive section is substantially strip-like and extends in the longitudinal direction of the line.

The present invention relates to a multilayered line, preferably a fuel line for automotive vehicles, comprising at least one support layer and at least one electrically conductive section which is connected to the support layer at least indirectly.

Such multilayered flexible lines which are capable of discharging electrostatic energy are known from the prior art. They are often used as a fuel line in automotive vehicles. Normally, the electrically conductive section forms the innermost layer of the line. The electrically conductive layer is firmly connected to the support layer which may either be an adhesive layer or an intermediate layer or also cover. This support layer may e.g. be a support layer of elastomer or plastics. The lines may be provided as pressure carriers, e.g., with a textile insert. On the whole, such lines are relatively thick-walled lines. Since the space inside the engine compartment is very confined, the fuel lines are bent into different directions several times. Narrow radii of curvature of the fuel line are here required in part. Due to the curvature, compressions are observed in the interior of the line in the inner radius of the bent portion, and overstretching occurs in the outer radius of the bent portion. The compressions, in particular, have turned out to pose problems. The compressions cause undulations in the inner radius of the bent line. The conductive innermost layer, in particular, is considerably stressed due to these undulations.

Although—in comparison with formerly used lines—the problem that the electrically conductive layer detaches from the support layer could be mitigated in the meantime. the electrically conductive layer may still get damaged by the narrow radii of curvature.

The undulations, in turn, have convex and concave sections, resulting—in particular in the convexly bent portion—in narrow radii of curvatures which create excessive stresses that during manufacture, or later under test conditions, cause transverse and longitudinal cracks in the electrically conductive layer.

In particular in the case of pulsating compressive stresses, as arise during the supply of fuels, these cracks may have disadvantageous effects on the strength of the line. The supplied fuel penetrates via the cracks into the line, additionally developing a notch effect which may cause a further tearing in the area of the cracks. Moreover, the cracks may extend completely through the electrically conductive layer, so that the electrically conductive layer is interrupted in sections. This may have a disadvantageous effect on electrical conductivity. Since the electrically conductive layer is to discharge static electricity in the longitudinal direction of the line, said crack formation in transverse direction may have the effect that conductivity is partly reduced. Moreover, the permeation characteristics of the line are deteriorated.

It is therefore the object of the present invention to improve a multilayered line of the above-mentioned type in such a way that its production reliability and service life are enhanced, and that electrical conductivity can also be ensured under adverse conditions.

This object is achieved according to the invention by a multilayered line of the above-mentioned type in which the conductive section is substantially strip-like and extends in the longitudinal direction of the line.

This solution has the advantage that the strip-like section can be laid such that the curvature of the line just effects a stretching of the strip if only one strip is provided. In addition, the strip-like design of the conductive section makes it possible to impart a particularly high conductivity to the conductive section without the strength of the line being significantly reduced thereby. The loads caused by the curvature of the line and the partial overstretching of the inner layer can now be transmitted to an increased degree to the layers of the line that are adjacent the conductive section. It has been found that with the design of the line according to the invention the crack formation in the inner surface of the line could be eliminated entirely. This yielded an improved fatigue strength of the line without restricting conductivity.

In an advantageous embodiment of the invention, the conductive section may be connected via a carrier layer to the support layer. Thanks to such a carrier layer, the strength of the connection can once again be increased between the support layer and the conductive section. In addition, loads which arise due to the bending of the line can be displaced out of the conductive section into the carrier layer.

Moreover, it may turn out to be an advantage when the strip-like section comprises a basic material and an electrically conductive material. The properties of the material of the strip-like section can also be improved thereby. Depending on the selection of the basic material, the adhesive characteristics between carrier layer and/or support layer can be improved.

To improve the connection between the strip-like section and the carrier layer, the basic material may also be contained in the carrier layer. When both carrier layer and conductive section have the same basic material, it is possible to establish an intimate and firm connection between the conductive section and the carrier layer.

In an advantageous embodiment of the invention, the strip-like section may extend in parallel with the longitudinal extension of the line. The strip-like sections can thus be made as short as possible.

Furthermore, it may turn out to be of advantage when the strip-like section projects into the carrier layer. A particularly intensive connection between carrier layer and conductive section can be established with such a projection. The strip-like section does here not form the whole layer thickness.

It may turn out to be of advantage when the lumen of the line is defined in sections by the carrier layer and the electrically conductive section. The loads created by the bending of the line can thereby be displaced into the carrier layer.

It may be of advantage when in the circumferential direction of the line the radial extension of the strip-like section is larger in the center than on the lateral edges. A reasonable compromise can thereby be achieved between conductivity and strength of the conductive section.

It may also turn out to be of advantage when the radial extension of the strip-like section is not more than half, preferably not more than one eighth of, the radial layer thickness of the carrier layer. A high strength of the carrier layer can thereby be achieved together with a high conductivity of the conductive section.

Moreover, it may turn out to be of advantage when the width of the conductive section in circumferential direction is not more than one tenth, preferably one fourth, of the inner circumference of the line. It has been found that good conduction characteristics of the conductive section can be achieved together with an adequate strength of the line.

It may here be of advantage when the width of the strip-like section is not more than 3 mm, preferably not more than 1 mm.

It may also turn out to be of advantage when the layer thickness of the carrier is not more than 1 mm, preferably not more than 0.25 mm. This layer thickness permits a sufficient strength of the carrier layer together with good conduction characteristics of the conductive section.

Furthermore it may be of advantage when the basic material is a flexible plastic material. With such a flexible plastic material, the lines according to the invention can be produced more easily on an industrial scale. All plastics that are resistant to fuel and extrudable and have a permeation-inhibiting property are here suited.

It may be of advantage when the basic material of the conductive section contains THV. This material shows flexibility together with an adequately high strength. Moreover, it is suited for introducing conductive materials.

It may also turn out to be advantageous when the carrier layer contains a flexible plastic material. The lines according to the invention can thus also be produced more easily on an industrial scale. It may here be of advantage when the flexible plastic material of the carrier layer also contains THV. Since both the conductive section and the carrier layer may contain THV, an intimate connection can be established between the carrier layer and the conductive section. All plastics are here suited that are resistant to fuel and extrudable and show a permeation-inhibiting property.

To achieve the necessary electrical characteristics at low costs, the electrically conductive material may contain carbon. Thanks to the strip-like form of the conductive sections, copper, silver, nickel and other relatively expensive conductive materials can be used apart from elemental carbon (soot).

It may here be of advantage when the amount of electrically conductive material in the electrically conductive section is less than 12%. As a result, the conductive section has an adequately great strength.

Furthermore, it may be of advantage when the support layer comprises an elastomer. The manufacture of the line on an industrial scale can thereby be simplified as well. All fuel-resistant elastomers and plastics can be used as a protective layer.

To achieve flexibility and strength of the line as well as the desired properties, it may turn out to be of advantage when the layer thickness of the support layer is a multiple of the layer thickness of the carrier layer.

Furthermore, it may turn out to be of advantage when a plurality of spaced-apart conductive sections are provided in the circumferential direction of the line. Production reliability as well as operational reliability of the line according to the invention can thereby be increased.

It may be of advantage when four evenly spaced-apart strip-like conductive sections are provided, This results in a reasonable compromise between strength characteristics on the one hand and required conductivity on the other hand.

In an advantageous embodiment of the invention the line is a flexible tube. With such a tube, the advantages of the invention can be put into practice particularly well. The invention, however, may also be suited for relatively rigid pipes.

Operation and function of the invention shall now be explained in more detail in the following.

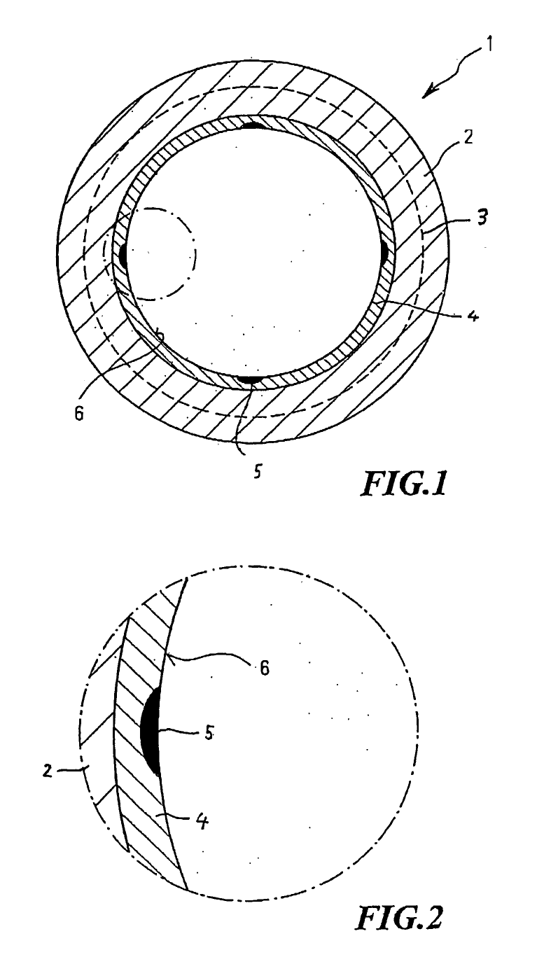

FIG. 1 is a cross-sectional view showing the line according to the invention;

FIG. 2 shows a detail of FIG. 1.

FIG. 1 is a cross-sectional view showing the multilayered line 1 according to the invention. The line is a flexible tube. Line 1 includes a support layer 2 of an elastomeric material with a textile insert 3. The support layer 2 is inwardly followed by a carrier layer 4 which is firmly connected to the support layer 2. The carrier layer 4 consists of THV, an extrudable plastic material. Furthermore, line 4 comprises electrically conductive sections 5 which extend in strip-like fashion in the longitudinal direction of the line or tube. The strip-like conductive sections consist of a basic material into which a conductive material has been introduced. In the preferred embodiment, the basic material is THV, an extrudable plastic material. At the same time, THV is also the material from which the carrier layer 4 has been made. The conductive material is carbon which has been introduced in powdered form into the conductive section. This yields a dark coloration of the conductive section, whereas the basic material THV is substantially transparent. The mixture of conductive material and basic material is also extrudable.

The illustration in FIG. 2 shows how the conductive section has been introduced into the carrier layer. The carrier layer and the conductive sections jointly define the lumen of the line or tube, the cross section of the line being substantially circular, resulting in a substantially cylindrical inner surface 6. When viewed in cross section, the conductive section extends into the carrier layer, the conductive section being defined in the area of the inner surface 6 by an extension of the inner surface in the form of a circular arc and being also defined in the manner of a circular arc at the side facing away from the inner surface, but with a smaller radius of curvature. This yields a crescent-like shape of the cross section of the conductive sections.

The layer thicknesses in radial direction are not true to scale in the illustrations in FIGS. 1 and 2. In a preferred embodiment, the layer thickness of the support layer 2 is about 14 mm. The layer thickness in the radial direction of the carrier layer is about 0.25 mm. The layer thickness of the support layer is thus up to about 16 times the layer thickness of the carrier layer. The radial extension of the conductive sections is about 0.05 mm and is thus within the preferred range where a ratio of radial extension of the conductive section to the layer thickness of the carrier layer is not more than about half, preferably not more than one eighth. The maximum extension of the conductive sections in circumferential direction is not more than one fourth of the inner circumference of the tube. In the preferred embodiment, four strip-like conductive sections are provided. However, the invention can also be carried out with only one conductive strip-like section or also with a number of conductive strip-like sections that is greater than four. At any rate, the inner surface of the line or tube should predominantly be formed by the carrier layer.

Number and dimensions of the conductive strip-like sections may depend on the necessary conductivity, but also on the strength of the line or tube.

A line or tube is considered to be conductive within the meaning of the invention if it meets the demands made by the car industry (e.g. DIN IEC 93- Classification VDE 0303 part 30; DIN EN ISO 8031) to discharge static electricity from the lines. To this end a specific minimum conductivity or a specific resistance is prescribed. The conductivity of the conductive layer is higher than that of the carrier layer by a multiple to permit a clear assignment between carrier layer and conductive section. The conductivity values of the present invention range from about 10⁴ to about 10⁶ ohm/cm².

Furthermore, it is also possible that the line or tube includes additional layers, such as a diffusion barrier layer of a fluoropolymer, or the like.

The line may be reshaped during production, so that the line assumes the necessary contour required e.g. for laying operations in an engine compartment of a vehicle. The reshaping process can here be performed not only within a plane, but within three dimensions.

Operation and function of the invention will now be explained in more detail:

With the line or tube according to the invention, it is possible to realize comparatively stable conductive sections which exhibit enough strength and can also follow pronounced curvatures of the line. Moreover, the formation of cracks in the conductive strips can be prevented in the area of compressions on the inside of the tube and of the resulting undulations. Even if one of the strips should be interrupted, electric current can still be transmitted through the remaining strips. Since both the conductive sections and the carrier material comprise the same basic material. an intimate connection is established between the conductive section and the carrier layer. Carrier layer and conductive section can reliably be prevented from breaking up. Since most of the load is carried by the carrier layer which is not weakened by the conductive material, the strength on the inside of the line is additionally enhanced.

Depending on the field of application, the line may also be made relatively stiff in the manner of a pipe.

Patent claims

1. A multilayered line, preferably a fuel line for automotive vehicles, comprising at least one support layer (2) and at least one electrically conductive section (5) connected at least indirectly to said support layer, characterized in that said conductive section is substantially strip-like and extends in the longitudinal direction of said line.

2. The multilayered line according to claim 1, characterized in that said conductive section is connected via a carrier layer (4) to said support layer.

3. The multilayered line according to claim 1 or 2, characterized in that said strip-like section comprises a basic material and an electrically conductive material.

4. The multilayered line according to any one of the preceding claims, characterized in that basic material is also contained in said carrier layer.

5. The multilayered line according to any one of the preceding claims, characterized in that said strip-like section extends in parallel with the longitudinal extension of said line.

6. The multilayered line according to any one of the preceding claims, characterized in that said strip-like section projects into said carrier layer in radial direction.

7. The multilayered line according to any one of the preceding claims, characterized in that the interior of said line is defined in sections by said carrier layer and said electrically conductive section.

8. The multilayered line according to any one of the preceding claims, characterized in that in the circumferential direction of said line the radial extension of said strip-like section is larger in the center than on the lateral edges.

9. The multilayered line according to any one of the preceding claims, characterized in that the radial extension of said strip-like section is not more than half, preferably one eighth of, the radial layer thickness of said carrier layer.

10. The multilayered line according to any one of the preceding claims, characterized in that the width of said conductive section in circumferential direction is not more than one fourth of the inner circumference of said line.

11. The multilayered line according to any one of the preceding claims, characterized in that the width of said conductive section is not more than 3 mm, preferably 1 mm.

12. The multilayered line according to any one of the preceding claims, characterized in that the layer thickness of said carrier layer is not more than 1 mm, preferably 0.25 mm.

13. The multilayered line according to any one of the preceding claims, characterized in that said basic material is a flexible plastic material.

14. The multilayered line according to any one of the preceding claims, characterized in that said basic material of said conductive section contains THV.

15. The multilayered line according to any one of the preceding claims, characterized in that said carrier layer contains a flexible plastic material.

16. The multilayered line according to any one of the preceding claims, characterized in that said flexible plastic material of said carrier layer contains THV.

17. The multilayered line according to any one of the preceding claims, characterized in that said electrically conductive material contains carbon.

18. The multilayered line according to any one of the preceding claims, characterized in that the amount of electrically conductive material in said electrically conductive section is not more than 12%.

19. The multilayered line according to any one of the preceding claims, characterized in that said support layer comprises an elastomer.

20. The multilayered line according to any one of the preceding claims, characterized in that the layer thickness of said support layer is a multiple of the layer thickness of said carrier layer.

21. The multilayered line according to any one of the preceding claims, characterized in that a plurality of spaced-apart sections are provided in the circumferential direction of said line.

22. The multilayered line according to any one of the preceding claims, characterized in that four equally spaced-apart strip-like sections are provided.

23. The multilayered line according to any one of the preceding claims, characterized in that said line is a flexible tube.

24. The multilayered line according to any one of the preceding claims, characterized in that said line is a pipe.
